(19) United States
(12) Patent Application Publication
(10) Pub. No.: US 2023/0147335 A1
(43) Pub. Date: May 11, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Kazuki NAGASHIMA, Kanagawa (JP); Takashi KIKUMOTO, Kanagawa (JP); Masatake KAWABE, Kanagawa (JP); Shogo ISHIKAWA, Kanagawa (JP); Naoto YAMASAKI, Kanagawa (JP)

(73) Assignee: FUJIFILM Business Innovation Corp., Tokyo (JP)

(21) Appl. No.: 17/739,156

(22) Filed: May 8, 2022

(30) Foreign Application Priority Data
Nov. 8, 2021 (JP) 2021-181739

(51) Int. Cl. H04N 1/44; G06F 3/12

(52) U.S. Cl. CPC H04N 1/444; H04N 1/448; G06F 3/1258; G06F 3/1204

(57) ABSTRACT

An information processing apparatus includes a processor configured to acquire a copy image, that is a copy of an image displayed on a display device, every time a predetermined timing occurs, and store the acquired copy image in a storage device in association with information indicating the predetermined timing that triggers the acquisition.

### CROSS-REFERENCE TO RELATED APPLICATIONS

This application is based on and claims priority under 35 USC 119 from Japanese Patent Application No. 2021-181739 filed Nov. 8, 2021.

### BACKGROUND

### (i) Technical Field

The present invention relates to an information processing apparatus, a non-transitory computer readable medium storing a program, and an information processing method.

### (ii) Related Art

An application is operated on various information processing apparatuses such as a personal computer (PC), a tablet, and a smartphone, and a user's operation is performed on a Graphical User Interface (GUI) provided by the application. Various settings of the application, execution of processes, or the like are performed by the user's operation.

JP5931806B discloses an automatic operation apparatus that records a user's operation on the GUI of an operation target application operating on a computer as a scenario, and replays the user's operation on the GUI of the operation target application on the computer by playing the scenario.

JP2020-017233A relates to an electronic device including a screenshot execution unit that acquires an image displayed on a display unit, and discloses a configuration in which in a case where an image requiring user authentication is displayed on the display unit, the acquisition of the image by the screenshot execution unit is prohibited, and in a case where an image that does not require user authentication is displayed on the display unit, the acquisition of the image by the screenshot execution unit is permitted.

### SUMMARY

In a case where a failure occurs in an application or an apparatus controlled by the application, or in a case where a desired result is not obtained as a result of processing by the application or the apparatus, there is a request to check later which operation was performed by the user on the GUI provided by the application and investigate the cause and factor of the failure and processing result. Such a user's operation may be checked from the log information (history information) recorded in the computer, but the user's operation cannot be checked easily in many cases.

Aspects of non-limiting embodiments of the present disclosure relate to an information processing apparatus, a non-transitory computer readable medium storing a program, and an information processing method that facilitate later checking an operation performed by a user with respect to an application operating in an information processing apparatus, as compared with a case where only log information is used.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: acquire a copy image, that is a copy of an image displayed on a display device, every time a predetermined timing occurs; and store the acquired copy image in a storage device in association with information indicating the predetermined timing that triggers the acquisition.

### BRIEF DESCRIPTION OF THE DRAWINGS

Exemplary embodiment(s) of the present invention will be described in detail based on the following figures, wherein:

FIG. 1 is a schematic configuration diagram of a printing system;

FIG. 2 is a functional block diagram of a print control apparatus;

FIG. 3 is a diagram showing an example of an image displayed on a display device of the print control apparatus;

FIG. 4 is a diagram showing an example of the image displayed on the display device of the print control apparatus;

FIG. 5 is a diagram showing an example of the image displayed on the display device of the print control apparatus;

FIG. 6 is a diagram for explaining a periodic SCS;

FIG. 7 is a diagram showing an example of a file name of the periodic SCS;

FIG. 8 is a diagram for explaining a user event SCS;

FIG. 9A is a diagram showing an example of a file name of the user event SCS;

FIG. 9B is a diagram showing an example of a file name of the user event SCS;

FIG. 10A is a diagram showing an example of a file name of a device event SCS;

FIG. 10B is a diagram showing an example of the file name of the device event SCS;

FIG. 11 is a diagram showing an example of an SCS setting window;

FIG. 12 is a diagram showing an example of a detailed setting window of SCS;

FIG. 13 is a flowchart showing a flow of acquisition of SCS;

FIG. 14 is a diagram showing an example of SCS modes according to user attributes;

FIG. 15 is a diagram showing an example of an SCS mode according to an operating time of an apparatus;

FIG. 16 is a diagram showing an example of a verification window;

FIG. 17 is a flowchart showing a flow of verification using SCS; and

FIG. 18 is a diagram showing an example of a player window.

### DETAILED DESCRIPTION

Hereinafter, each exemplary embodiment of the present invention will be described in detail with reference to the accompanying drawings. The configuration described below is an example for explanation, and can be appropriately changed according to the specifications of the system and the apparatus. Further, in a case where a plurality of exemplary embodiments, modification examples, and the like are included in the following, it is assumed from the beginning that the characteristic portions are appropriately combined and used. The same elements are designated by the same reference numerals in all drawings, and duplicate description is omitted.

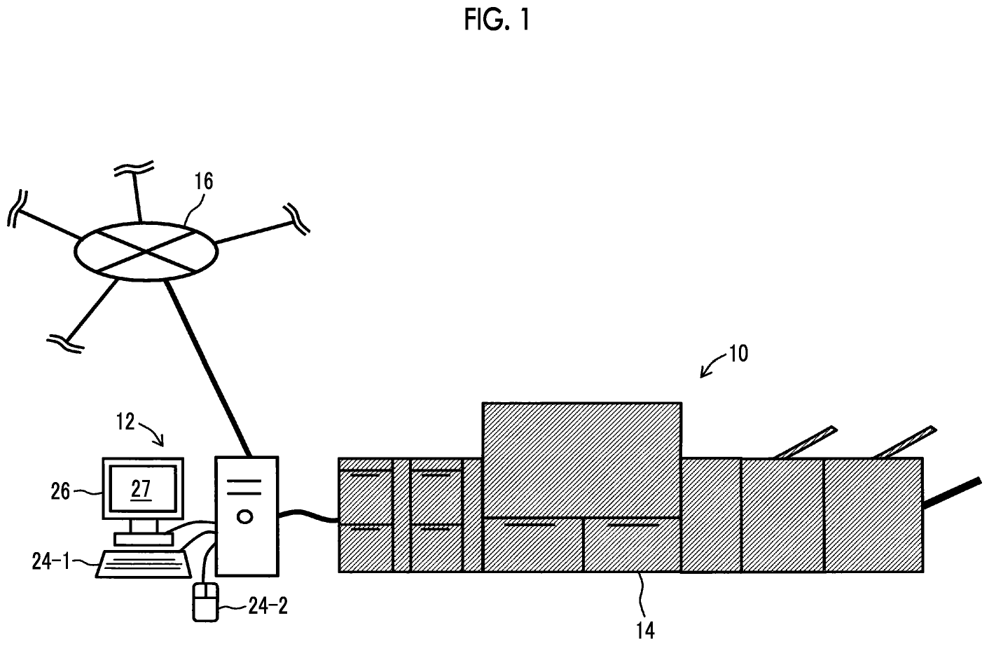

FIG. 1 is a schematic configuration diagram of a printing system 10. The printing system 10 is a printed matter manufacturing system used by a printing company engaged in a printed matter manufacturing business, a department that produces a large number of printed matters in a company, and the like.

The printing system 10 includes a print control apparatus 12 and a printing apparatus 14. The print control apparatus 12 is communicably connected to the printing apparatus 14. The print control apparatus 12 is communicably connected to another computer via a network 16. The network 16 is, for example, a LAN, an intranet, the Internet, or the like.

The printing apparatus 14 is an apparatus that forms an image on a medium such as paper, and is also called an image forming apparatus. The printing apparatus 14 is a digital printing machine such as an electrophotographic printing apparatus and an inkjet printing apparatus, and in this exemplary embodiment, the printing apparatus 14 is a production printer capable of printing at high speed. By selectively adding modules, the printing apparatus 14 can have a function of post-processing (punching (hole punching) processing, staple processing, saddle stitching processing, folding processing, cutting processing, or the like). According to the printing apparatus 14 having the post-processing function, it is possible to perform post-processing after printing on paper, and output a printed matter such as a booklet.

The print control apparatus 12 is a computer called a Digital Front End (DFE) or a print server. An operating system and a printing application operating on the operating system are installed in the print control apparatus 12. The print control apparatus 12 provides various print-related functions depending on the operation of the printing application.

The print control apparatus 12 receives a print job from another computer via the network 16, and manages the print job. The print job is a unit of processing in the printing system 10, and includes print setting information and document and image data to be printed. The print control apparatus 12 receives an operation from the operator to make various settings for the print job, or performs Raster Image Processer (RIP) processing on the image data of the print job to generate a raster image. Further, the print control apparatus 12 receives a print instruction from the operator and supplies a print processing command including various parameters, a raster image, or the like, corresponding to the print job, to the printing apparatus 14, so that a printed matter is output from the printing apparatus 14. The print control apparatus 12 also functions as an apparatus for managing the state of the printing apparatus 14 or making various settings for the printing apparatus 14. The print control apparatus 12 also functions as an apparatus for controlling the operation of the printing apparatus 14.

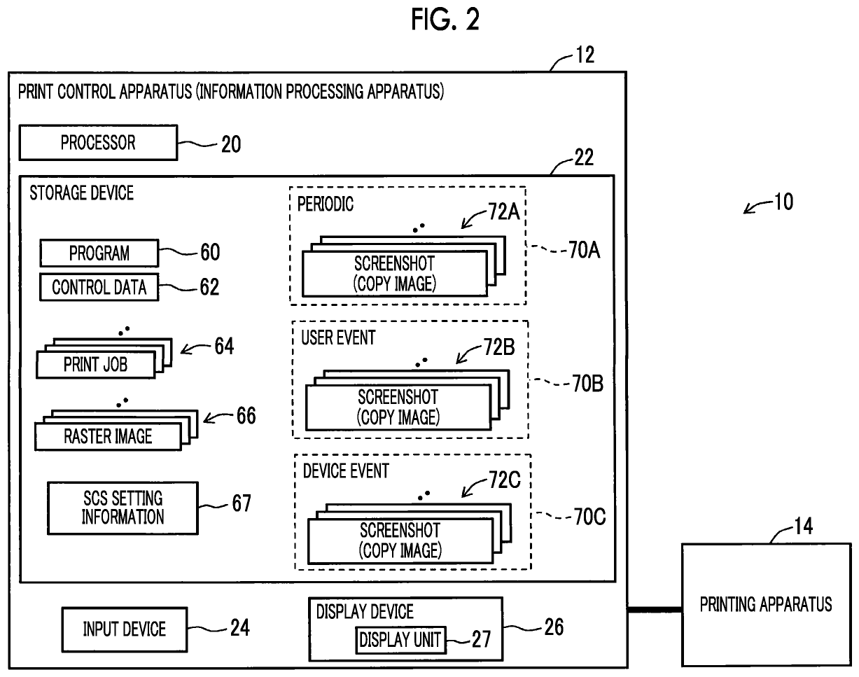

FIG. 2 is a functional block diagram of the print control apparatus 12. The print control apparatus 12 as an information processing apparatus includes a processor 20, a storage device 22, an input device 24, and a display device 26. The processor 20 includes a CPU and executes information processing according to the program 60 installed in the print control apparatus 12 and the control data 62. The processor 20 can be defined as a computer in a narrow sense.

The storage device 22 is a ROM, a RAM, a flash memory, a hard disk, or the like. The storage device 22 stores the program 60, control data 62, a print job 64, a raster image 66, screenshot (SCS) setting information 67, screenshots 72A, 72B, 72C, and the like. The program 60 and the control data 62 include programs and control data for both the operating system and the printing application, respectively.

The program executed by the processor 20 and the control data to be read can be provided not only via a network such as the Internet but also stored in a computer-readable recording medium such as an optical disk or a USB memory.

The screenshots 72A, 72B, and 72C are electronic files (hereinafter, also referred to as copy images) of images showing all or a part of the display object (display screen image) displayed on the display device 26 of the print control apparatus 12. That is, the screenshots 72A, 72B, and 72C are copy images that are copies of all or a part of the image displayed on the display device 26 of the print control apparatus 12. In this exemplary embodiment, the screenshots 72A, 72B, 72C are electronic files (copy images) of an image showing the entire display object displayed on the display device 26. Hereinafter, the screenshot is also referred to as “SCS”.

The screenshot 72A is acquired at a predetermined time interval (also referred to as periodic), and is hereinafter referred to as a periodic SCS (72A). The screenshot 72B is acquired at the timing when the user performs a predetermined operation (also referred to as a user event) on the GUI of the print control apparatus 12, and is hereinafter referred to as a user event SCS (72B). The screenshot 72C is acquired at the timing when a predetermined event (also referred to as a device event) of the printing application and the operating system or a predetermined event (device event) of the printing apparatus 14 controlled by the printing application occurs, and is hereinafter referred to as a device event SCS (72C). Hereinafter, in a case where it is not necessary to distinguish between the periodic SCS (72A), the user event SCS (72B), and the device event SCS (72C), the periodic SCS (72A), the user event SCS (72B), and the device event SCS (72C) are referred to as screenshot 72 or SCS (72).

The storage device 22 stores a periodic folder 70A, a user event folder 70B, and a device event folder 70C. The periodic SCS (72A) is stored in the periodic folder 70A. The user event SCS (72B) is stored in the user event folder 70B. The device event SCS (72C) is stored in the device event folder 70C.

The input device 24 is a keyboard 24-1, a mouse 24-2 (see FIG. 1), a touch panel, and the like, which are operated by an operator. The display device 26 is a display, and includes a display unit 27 such as a liquid crystal panel or an organic EL panel. A display object (display screen image) is displayed on the display unit 27 of the display device 26.

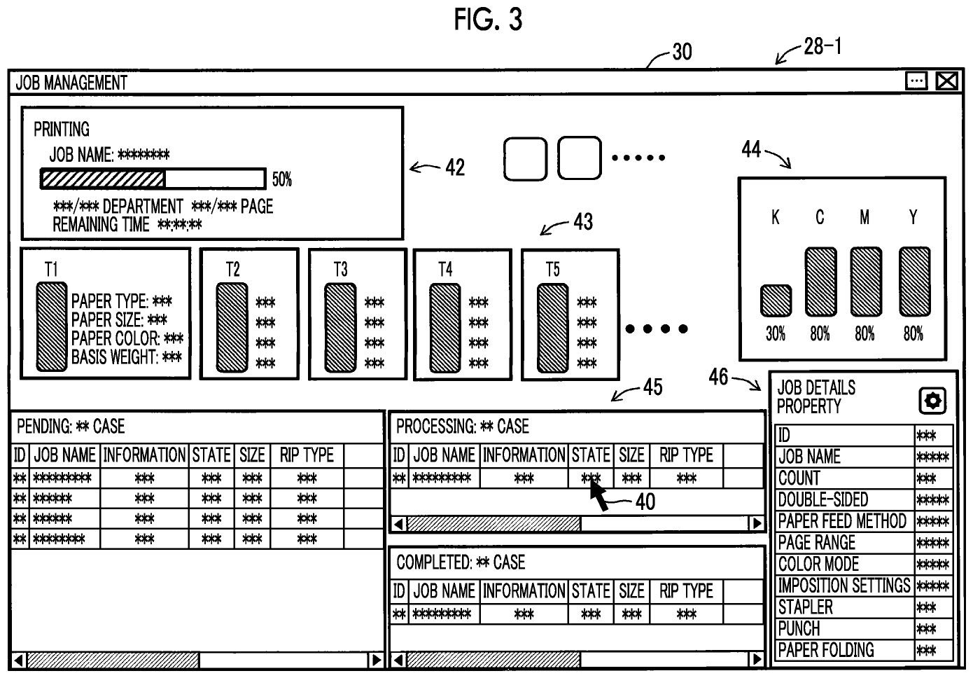

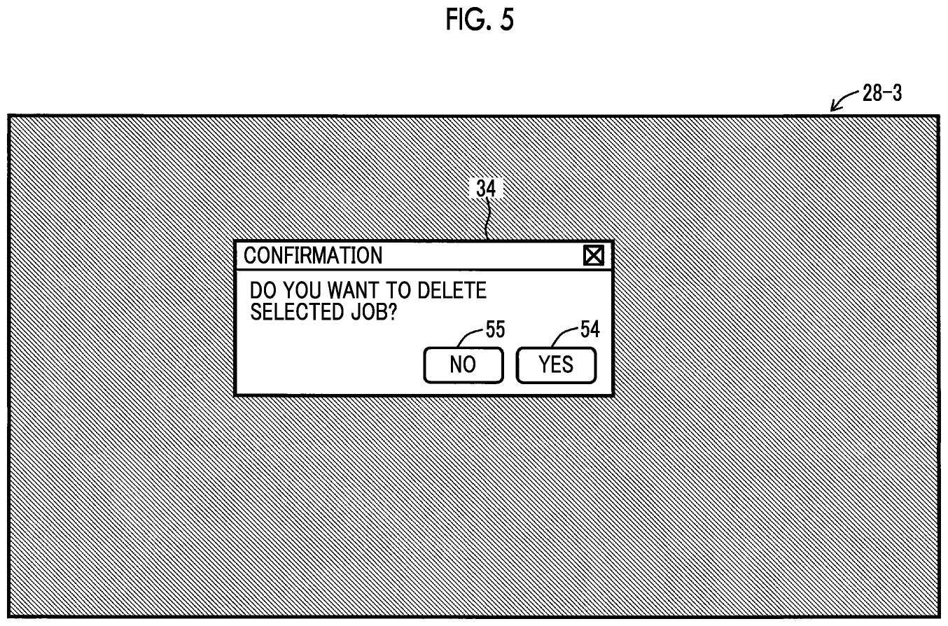

FIGS. 3 to 5 are examples of display screen images 28-1 to 28-3 displayed on the display device 26 of the print control apparatus 12 while the printing application is operating on the print control apparatus 12. These display screen images 28-1 to 28-3 are also examples of images acquired as SCS (72). In FIG. 5, the image around the window 34 in the display screen image 28-3 is omitted.

FIG. 3 illustrates a window 30 relating to job management. The window 30 contains various types of information. The window 30 includes a print information portion 42, a tray information portion 43, a toner information portion 44, a print job list information portion 45, and a print job detailed information portion 46.

On the print information portion 42, the print progress information of the print job being printed by the printing apparatus 14 is displayed. On the tray information portion 43, paper information (paper type, paper size, paper color, basis weight, or the like) set for each of the plurality of paper trays of the printing apparatus 14 is displayed. The paper information on each paper tray is set by the user. The paper actually put in the paper tray needs to match the paper shown in the tray information portion 43, but in a case where the papers are different due to a setting error or the like, the intended print result may not be obtained.

On the toner information portion 44, information on the remaining amount of the toner of each of CMYK colors is displayed. On the print job list information portion 45, information on each print job is displayed in a form in which with respect to the print jobs stored in the print control apparatus 12, the print jobs are classified according to the print job states (pending, processing, and completed). On the print job detailed information portion 46, detailed information on the print job designated by the cursor 40 in the print job list information portion 45 is displayed. In a case where the display image 28-1 as shown in FIG. 3 is acquired as the SCS (72), a lot of pieces of information can be obtained from the SCS (72).

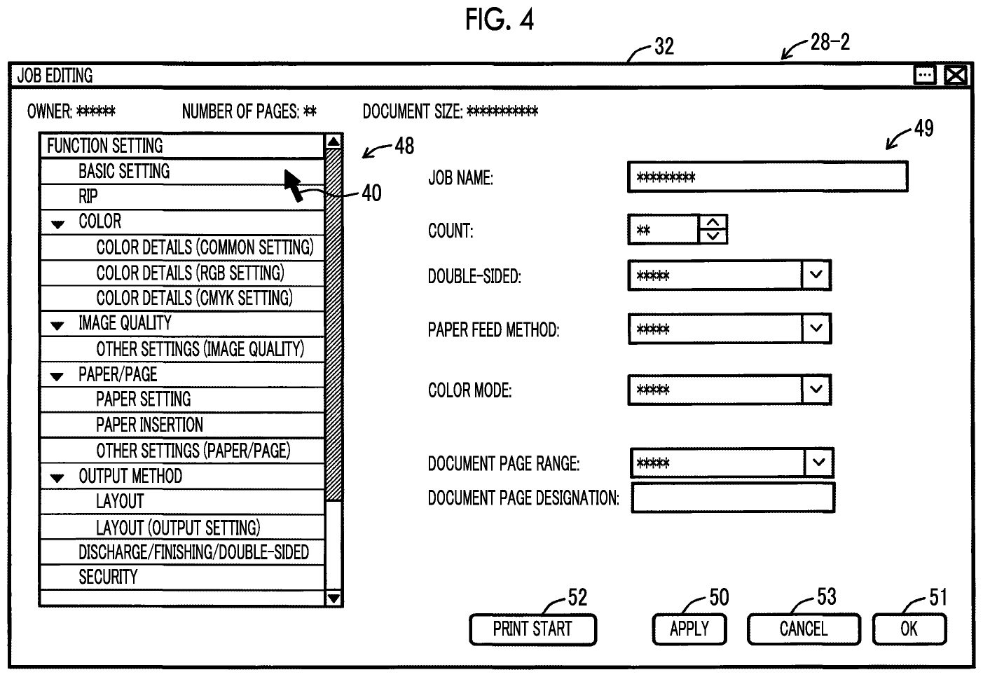

FIG. 4 shows a window 32 relating to job editing. The window 32 is a window for setting attribute information (including print setting information) on one print job designated by the user. The window 32 includes a function item portion 48 having a plurality of items, and an input portion 49 on which text boxes, pull-down menus, or the like for inputting information about the designated item are displayed, in a case where one of the plurality of items in the function item portion 48 is designated by the cursor 40. The user moves the cursor 40 by operating the mouse, designates a desired item in the function item portion 48 with the cursor 40 to make the input portion 49 to display a text box or a pull-down menu for inputting information regarding the designated item. Then, the user inputs or designates a desired value or the like by operating the keyboard or mouse in the text box or pull-down menu displayed on the input portion 49, and presses the “apply” button 50 or the “OK” button 51 to set the attribute information of the print job.

The production printer has various functions, and detailed settings can be made for each function. For example, in the function item portion 48 of FIG. 4, in the item of “color”, it is possible to designate whether or not to apply and parameter values for various color corrections. Further, in the item of “paper/page”, it is possible to set detailed paper information (paper type, paper size, paper color, basis weight, or the like) for each of a large number of paper trays. The printer profile and the like used at the time of printing are determined by the setting of this paper information. Further, in the item of “output method”, various types of imposition settings, margin settings, and the like can be made.

FIG. 5 shows a window 34 relating to job deletion. The window 34 is a confirmation window displayed in a case where one print job is designated by the user and an instruction to delete the print job is given. Such confirmation/warning windows frequently appear while the user operates the GUI of the printing application.

Here, in the printing application, in a case where the user performs various settings and instructions, a failure such as an error may occur in the printing application or the printing apparatus 14 controlled by the printing application. Further, the processing result of the printing application (for example, a raster image after RIP processing) or the printed matter output from the printing apparatus 14 may not be the desired result. In the present exemplary embodiment, in preparation for such a case, the SCS (72) is acquired every time a predetermined timing occurs, and what type of operation is performed by the user on the printing application from the SCS (72) can be checked later, so that the causes and factors for failures and processing results can be investigated. For example, the user or the user's employer passes the periodic folder 70A, the user event folder 70B, and the device event folder 70C to the manufacturing company of the printing system 10, the company that provides after-sales service, or the like, and the companies verify the causes and factors for failures and processing results from SCS (72) in each folder.

In particular, since various functions can be set in detail in the printing application of a production printer, as shown in FIG. 4, the user may unintentionally make an incorrect setting, which results in a failure or an unintended processing result. On the other hand, as a display image of a printing application, as shown in FIG. 3, a lot of pieces of information may appear. Therefore, it is very effective to use the SCS (72) to verify the causes and factors for failures and unintended processing results. In the related art, such verification has been performed using log information (character information recorded by associating the event occurrence date and time with the event occurrence content), but by using the SCS (72) in place of log information or together with log information, it is possible to facilitate verification of failures and processing results as compared with the case where only log information is used.

Further, as described below, in the present exemplary embodiment, the file name of the SCS (72) and information indicating a predetermined timing that triggers the acquisition of the SCS (72) are stored in the storage device. This makes it easier to find out which SCS (72) to check in order to investigate the causes and factors for failures and processing results in the printing application and the printing apparatus.

The SCS (72) is acquired, for example, as follows. First, the printing application issues a capture instruction to acquire a display screen image at a predetermined timing (periodic, user event, or device event), and the operating system receives the capture instruction. Upon receiving the capture instruction, the operating system copies the display screen image displayed on the display device 26 to the clipboard and sends a copy completion notification to the printing application. Upon receiving the copy completion notification, the printing application stores the image on the clipboard in the storage device 22 as an electronic file (copy image) with a file name described below. Thus, the SCS (72) is acquired.

As the acquisition timing of the SCS (72), a timing when the periodic time elapses, a timing when the screen on the display device 26 changes, a timing when the state of the operating system/printing application/printing apparatus/print job changes, a timing when an operation on a print job is performed, a timing when an error has occurred, or the like is considered. In order to deal with these, in the present exemplary embodiment, the SCS (72) is acquired at the periodic, user event, and device event timings. The SCS (72) may be acquired at the timing of one or two of the periodic, user event, and device event.

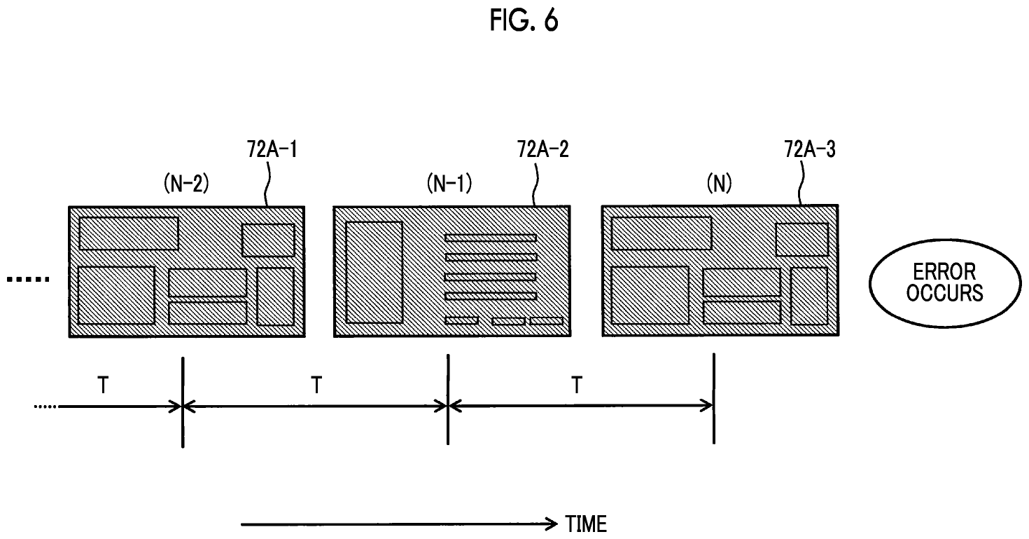

FIG. 6 is a diagram for explaining the periodic SCS (72A). The periodic SCS (72A) is acquired at a predetermined time interval T (hereinafter, also referred to as a period T). FIG. 6 shows a plurality of periodic SCSs (72A-1, 72A-2, 72A-3) before the error occurred. The period T is, for example, time such as 1 minute, 30 seconds, 1 second, and less than 1 second, and is not limited.

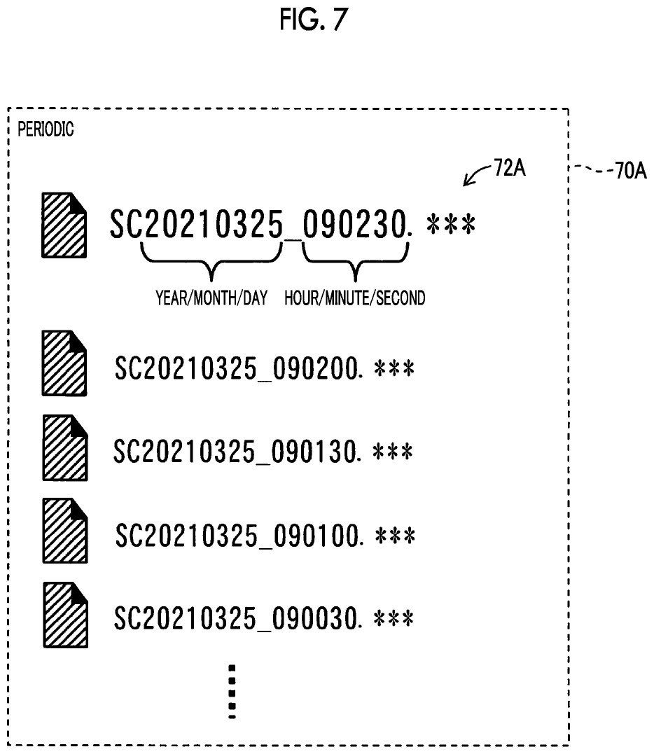

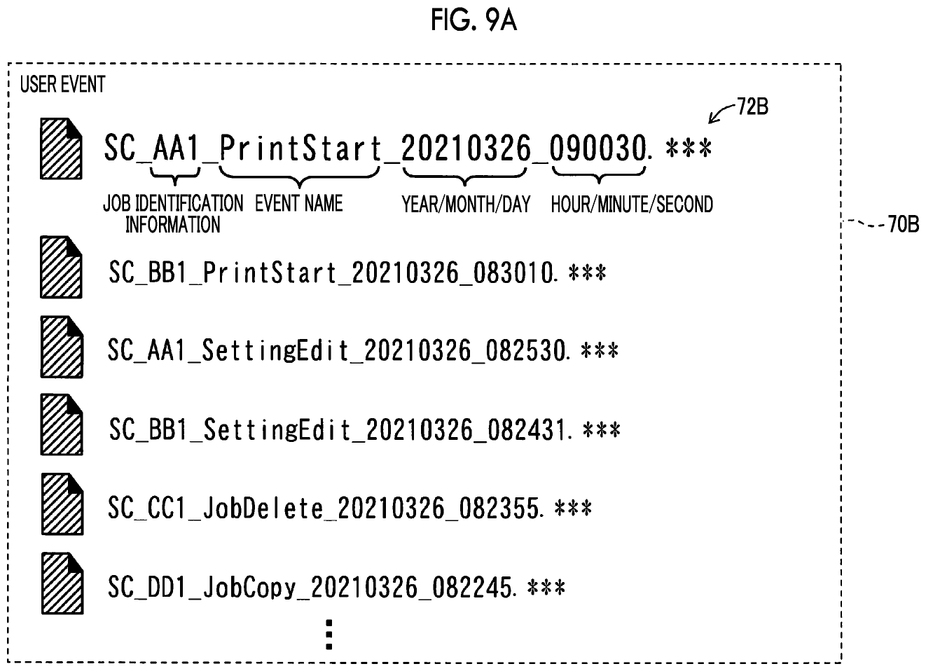

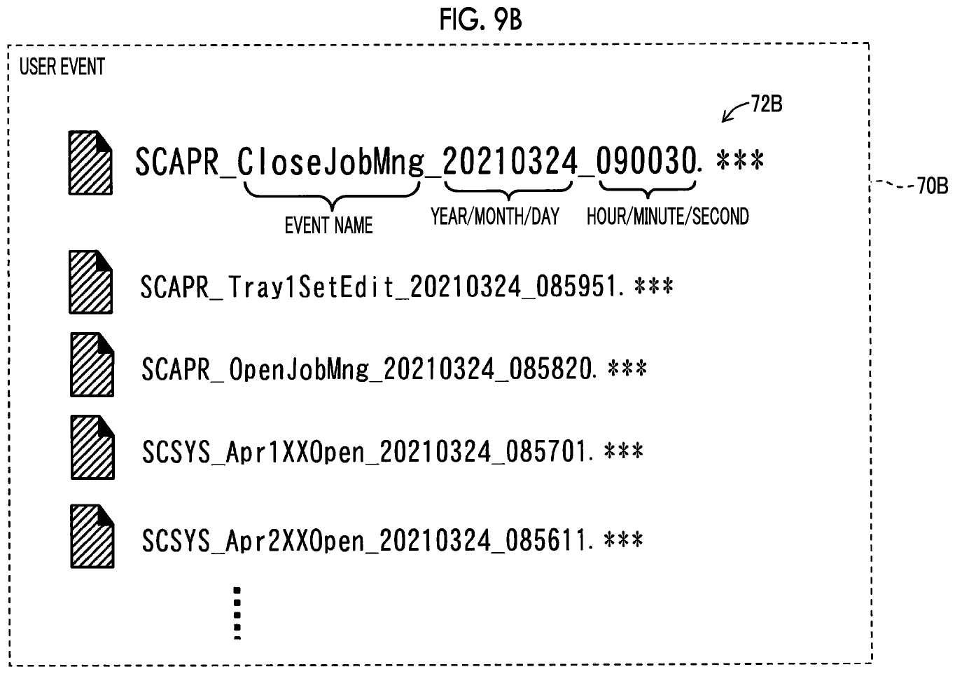

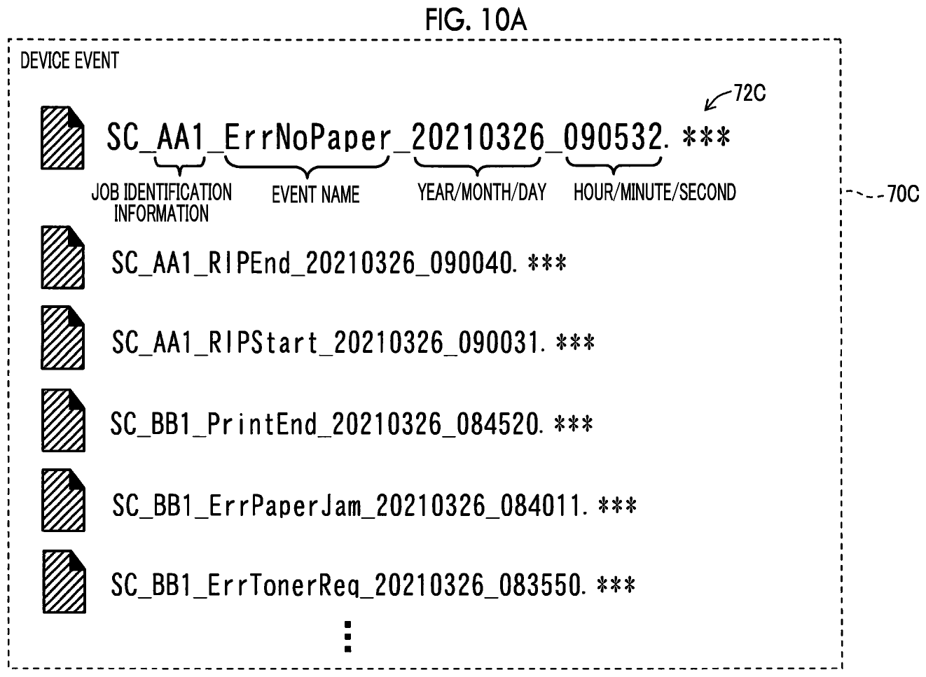

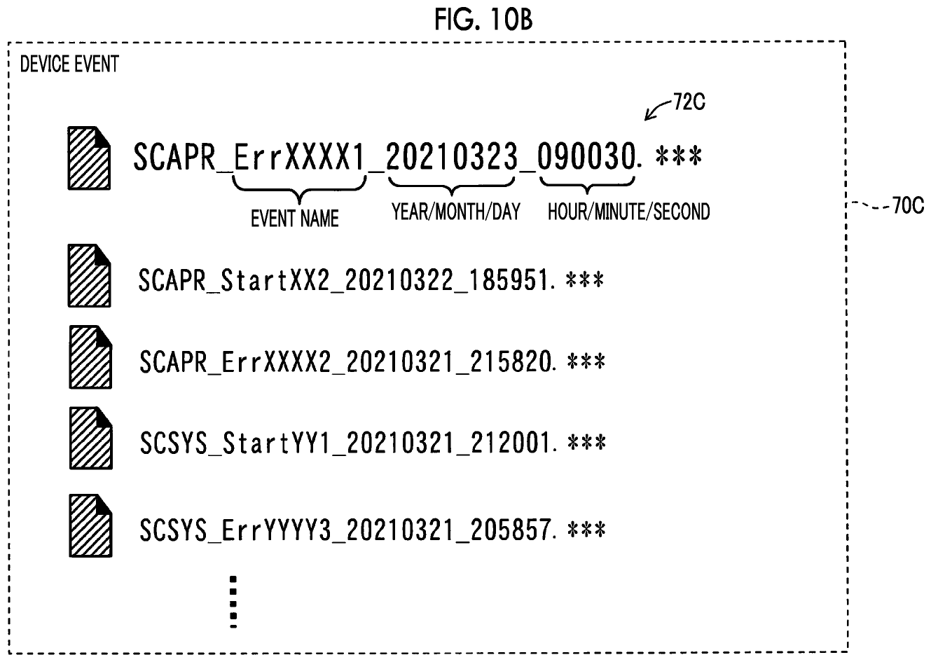

FIG. 7 shows an example of the file name of the periodic SCS (72A) stored in the periodic folder 70A. In FIG. 7, a description of the file name is added to the first periodic SCS (72A), and the same applies to FIGS. 9A, 9B, 10A, and 10B described below. As shown in FIG. 7, the acquisition date and time is added to the file name of the periodic SCS (72A). FIG. 7 shows an example in which periodic SCS (72A) is acquired with a period T=30 seconds and the acquisition date and time is added to the file name of each periodic SCS (72A). For example, in a case where the date and time when the error occurs is known, the causes and factors for the error can be grasped by checking the periodic SCSs (72A) with the file names including the acquisition dates and times in order from immediately before the occurrence to the past.

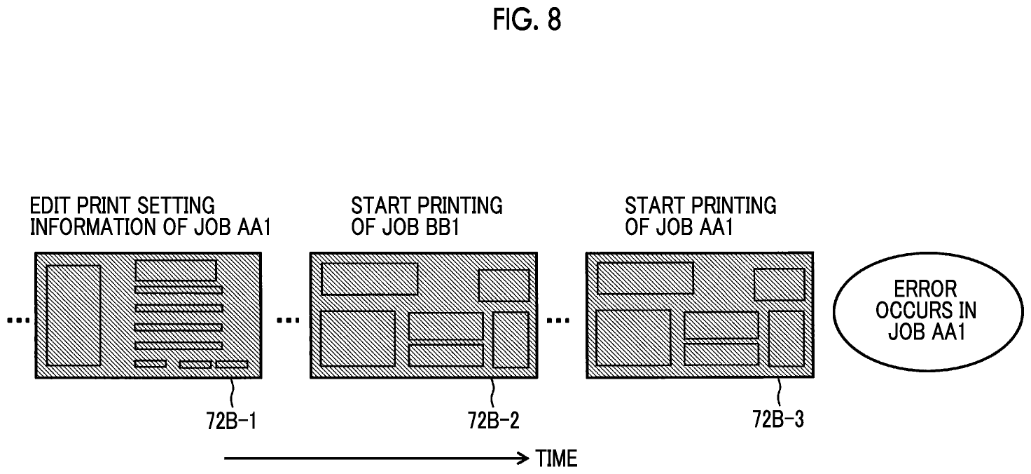

FIG. 8 is a diagram for explaining the user event SCS (72B). The user event SCS (72B) is acquired at the timing when the user performs a predetermined operation. The predetermined operation is a predetermined user's operation that causes a change in the display screen image of the display device 26. Examples of the predetermined operation include a user operation for opening and closing various windows, a user operation for designating a print job and various items with the cursor 40 as shown in FIGS. 3 and 4, a user operation for pressing the buttons 50 to 55 for giving various instructions as shown in FIGS. 4 and 5, or the like. In addition, as the user event SCS (72B), in a case where the display screen image of the display device 26 changes by the user performing a predetermined operation, one of the display screen images before and after the change is acquired. However, as the user event SCS (72B), both display screen images of the display device 26 before and after the change may be acquired. FIG. 8 shows a plurality of user events SCS (72B-1, 72B-2, 72B-3) before an error occurs regarding the print job AA1 (“AA1” is the identification information of the print job).

FIGS. 9A and 9B show an example of the file name of the user event SCS (72B) stored in the user event folder 70B. FIG. 9A shows a user event SCS (72B) acquired as a result of a user's operation regarding the setting or processing of a print job. FIG. 9B shows a user event SCS (72B) acquired as a result of a user operation that is not limited to a specific print job or a user operation not related to the print job.

The file name of the user event SCS (72B) in FIG. 9A is added with the identification information (job identification information) on the print job related to the user operation that triggers the acquisition of the SCS, information (event name) indicating the user's operation that triggers the acquisition of the SCS, and the date and time (year/month/day, hour/minute/second) when the user performed the operation that triggers the acquisition of the SCS. In the user event SCS (72B) of FIG. 9A, “AA1”, “BB1”, “CC1”, and “DD1” are print job identification information, “Print Start” means the start of printing of the print job, “SettingEdit” means to edit the print setting information of the print job, “JobDelete” means to delete the print job, and “JobCopy” means to copy the print job. For example, as shown in FIG. 8, in a case where the identification information (AA1) on the print job in which the error has occurred and the date and time of the occurrence are known, and by searching for and checking the user event SCS (72B) of which the file name has the date and time from immediately before the error occurrence date and time to the past, and the identification information (AA1) on the print job in which the error has occurred, the cause and factor of the error can be easily grasped.

“SCAPR” or “SCSYS” is added to the file name of the user event SCS (72B) in FIG. 9B, indicating that the SCSs are acquired by a user operation not limited to a specific print job. “SCAPR” indicates that the SCS is acquired as a result of a user operation on the printing application, and “SCSYS” indicates that the SCS is acquired as a result of a user operation on the operating system. The file name of the user event SCS (72B) in FIG. 9B is added with the information (event name) indicating the user's operation that triggers the acquisition of the SCS, and the date and time (year/month/day, hour/minute/second) when the user performed the operation that triggers the acquisition of the SCS. In FIG. 9B, “CloseJobMng” means an operation of closing the print job management window, “Tray1SetEdit” means an operation of editing the paper information of the paper tray 1 of the printing apparatus, “OpenJobMng” means an operation to open the print job management window, and “Apr1XXOpen” and “Apr2XXOpen” mean operations to open an application different from the printing application. According to the user event SCS (72B) of FIG. 9B, for example, in a case where the date and time when the error occurred is known, by searching for the SCS (72B) having the date and time from immediately before the error occurrence date and time to the past in the file name, and then among the searched SCS, finding and checking the SCS (72B) having an “event name” in the file name that is likely to be related to the error that occurred, the cause and factor of the error can be grasped.

FIGS. 10A and 10B show an example of the file name of the device event SCS (72C) stored in the device event folder 70C. The device event SCS (72C) is acquired at the timing when a predetermined event of the printing application, the operating system, and the printing apparatus 14 occurs. The predetermined event is an event that is automatically generated by the printing application, the operating system, or the printing apparatus 14 without any user's operation. Examples of the predetermined event include the start, end, error, state change, or the like of various processes in the printing application and operating system, and errors (paper jam, or the like), various requests (paper replenishment, toner replacement request, or the like), state change, or the like in the printing apparatus 14. In a case where as the device event SCS (72C), a predetermined event occurs and the display screen image of the display device 26 changes, one of the display screen images before and after the change is acquired. However, as the device event SCS (72C), both display screen images of the display device 26 before and after the change may be acquired.

FIG. 10A shows a device event SCS (72C) acquired as a result of an event related to the processing of a print job. FIG. 10B shows a device event SCS (72C) acquired as a result of an event not limited to a specific print job or an event not related to the print job.

The file name of the device event SCS (72C) in FIG. 10A is added with the identification information (job identification information) on the print job related to the event that triggers the acquisition of the SCS, information (event name) indicating the event that triggers the acquisition of the SCS, and the date and time (year/month/day, hour/minute/second) when the event that triggers the acquisition of the SCS occurred. In the device event SCS (72C) of FIG. 10A, “AA1” and “BB1” are print job identification information, “ErrNoPaper” means out of paper during printing of the print job, “RIPStart” means the start of RIP processing of the print job, “RIPEnd” means the end of RIP processing of the print job, “PrintEnd” means the end of printing of the print job, “ErrPaperJam” means the paper jam during printing of the print job, and “ErrTonerReq” means a toner replacement request during printing of a print job. For example, in a case where the identification information (for example, AA1) on the print job in which the error has occurred and the date and time of the occurrence are known, and by searching for and checking the device event SCS (72C) of which the file name has the date and time from immediately before the error occurrence date and time to the past, and the identification information (for example, AA1) on the print job in which the error has occurred, the cause and factor of the error can be easily grasped.

“SCAPR” or “SCSYS” is added to the file name of the device event SCS (72C) in FIG. 10B, indicating that the SCSs are acquired by an event not limited to a specific print job. “SCAPR” indicates that the SCS is acquired as a result of an event in a printing application and a printing apparatus, and “SCSYS” indicates that the SCS is acquired as a result of an event in the operating system. The file name of the device event SCS (72C) in FIG. 10B is added with the information (event name) indicating the event that triggers the acquisition of the SCS, and the date and time (year/month/day, hour/minute/second) when the event that triggers the acquisition of the SCS occurred. In FIG. 10B, “ErrXXXX1”, “ErrXXXX2” and “ErrYYYY3” mean an event related to an error, and “StartXX2” and “StartYY1” mean an event related to the start of processing. According to the device event SCS (72C) of FIG. 10B, for example, in a case where the date and time when the error occurred is known, by searching for the SCS (72C) having the date and time from immediately before the error occurrence date and time to the past in the file name, and then among the searched SCS, finding and checking the SCS (72C) having an “event name” in the file name that is likely to be related to the error that occurred, the cause and factor of the error can be grasped.

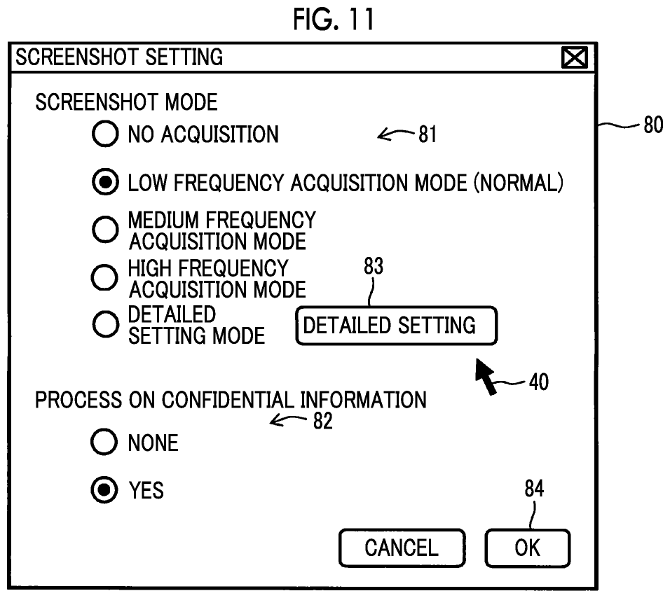

Next, the SCS mode will be described. FIG. 11 is a diagram showing a window 80 for setting the SCS mode. The window 80 is opened by a user's operation as one of the functions of the printing application. The window 80 includes a mode setting portion 81 and a concealment processing setting portion 82.

The mode setting portion 81 is a portion for designating whether or not to acquire the SCS (72), and for designating the frequency of acquiring the SCS (72) in a case where the SCS (72) is to be acquired. The mode setting portion 81 has options of “no acquisition”, “low frequency acquisition mode”, “medium frequency acquisition mode”, “high frequency acquisition mode”, and “detailed setting mode”, and one of the options is designated by the user using the radio button. “No acquisition” means that the SCS (72) is not to be acquired. “Low frequency acquisition mode”, “medium frequency acquisition mode”, and “high frequency acquisition mode” are modes prepared for switching the acquisition frequency of the periodic SCS (72A), and the number of periodic SCSs (72A) acquired per unit time increases in the order of the “low frequency acquisition mode”, the “medium frequency acquisition mode”, and the “high frequency acquisition mode”. For example, the “low frequency acquisition mode” is a mode for acquiring a periodic SCS (72A) with the period T=30 seconds, the “medium frequency acquisition mode” is a mode for acquiring a periodic SCS (72A) with the period T=10 seconds, and the “high frequency acquisition mode” is a mode for acquiring a periodic SCS (72A) with the period T=1 second.

In addition, in the order of “low frequency acquisition mode”, “medium frequency acquisition mode”, and “high frequency acquisition mode”, the number of “predetermined operations” that trigger the acquisition of the user event SCS (72B) is increased, and the acquisition frequency of the user event SCS (72B) may be changed by switching between these modes. Similarly, in the order of “low frequency acquisition mode”, “medium frequency acquisition mode”, and “high frequency acquisition mode”, the number of “predetermined events” that trigger the acquisition of the device event SCS (72C) is increased, and the acquisition frequency of the device event SCS (72C) may be changed by switching between these modes.

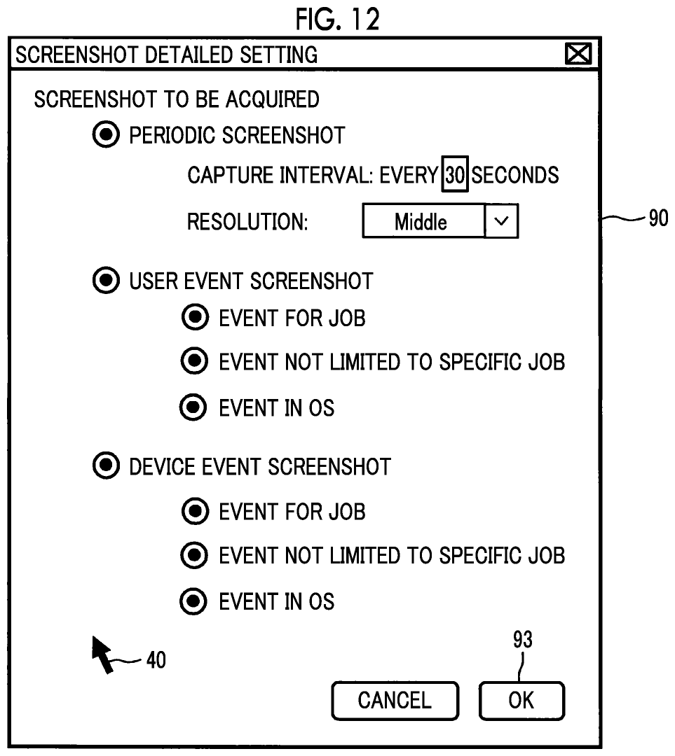

The “detailed setting mode” of the mode setting portion 81 is a mode for finely setting the acquisition specifications of the SCS (72), and is a mode for acquiring the SCS (72) according to the specifications designated in the detailed setting window 90 (see FIG. 12) opened by pressing the “detailed setting” button 83. As shown in FIG. 12, in the detailed setting window 90 has a radio button for each of the periodic SCS, the user event SCS, and the device event SCS, and the SCS with the radio button turned on (black circle is checked) is acquired. In a case where the radio button of the periodic SCS is turned on, the capture interval (period T) and the resolution of the periodic SCS are designated. The capture interval (period T) is designated by inputting a numerical value in the text box, and the resolution is designated by the pull-down menu from Low (low resolution), Middle (medium resolution), and High (high resolution).

In the detailed setting window 90, in a case where the radio button of the user event SCS is turned on, the radio button of each of “event for job (print job)”, “event not limited to specific job (print job)”, and “event in OS (operating system)” is set. In a case where the radio button of “event for job” is turned on, the user event SCS (72B) is acquired as a result of the user's operation related to the setting or processing of the print job. Further, in a case where the radio button of “event not limited to specific job” is turned on, the user event SCS (72B) is acquired as a result of an operation not limited to the specific print job of the user. Further, in a case where the radio button of “event in OS” is turned on, the user event SCS (72B) is acquired as a result of the user's operation on the operating system.

In the detailed setting window 90, in a case where the radio button of the device event SCS is turned on, the radio button of each of “event for job (print job)”, “event not limited to specific job (print job)”, and “event in OS (operating system)” is set. In a case where the radio button of “event for job” is turned on, the device event SCS (72C) is acquired as a result of the event related to the processing of the print job. Further, in a case where the radio button of “event not limited to specific job” is turned on, the device event SCS (72C) is acquired as a result of the event not limited to the specific print job. Further, in a case where the radio button of “event in OS” is turned on, the device event SCS (72C) is acquired as a result of the event in the operating system.

In the window 80 of FIG. 11, the concealment processing setting portion 82 is a part for setting whether or not to perform concealment processing in the area where the confidential information on the SCS (72) appears. The concealment processing setting portion 82 has options of “none” and “yes”, and one of the options is designated by the user using a radio button. “None” means that the concealment processing is not to be performed, and “Yes” means that the concealment processing is to be performed. For example, as shown in FIG. 3, the job name of the print job appears in the print job list information portion 45. The job name may include personal information (confidential information) such as the name of the requester for manufacturing the printed matter. The users of the printing system 10 and the employers may not want such confidential information to appear on the SCS (72), and may not want to pass the SCS (72) to the manufacturing company of the printing system 10, an after-sales service company, or the like for verification. Therefore, by selecting “Yes” in the concealment processing setting portion 82, concealment processing is performed on the part where the job name of the acquired SCS (72) appears, and the SCS (72) is updated, so that specific job names are prevented from appearing in the SCS (72). Although the job name is taken as an example of confidential information here, concealment processing may be performed on a portion where other confidential information appears.

By pressing the “OK” button 84 in the window 80 of FIG. 11 or the “OK” button 93 in the detailed setting window 90 of FIG. 12, information regarding the acquisition of the SCS (72) in the window 80 and the detailed setting window 90 described above is stored in the storage device 22 as the SCS setting information 67, and is applied to the print control apparatus 12. As the default setting of the window 80, “low frequency acquisition mode” may be designated in the mode setting portion 81, and “yes” may be designated in the concealment processing setting portion 82.

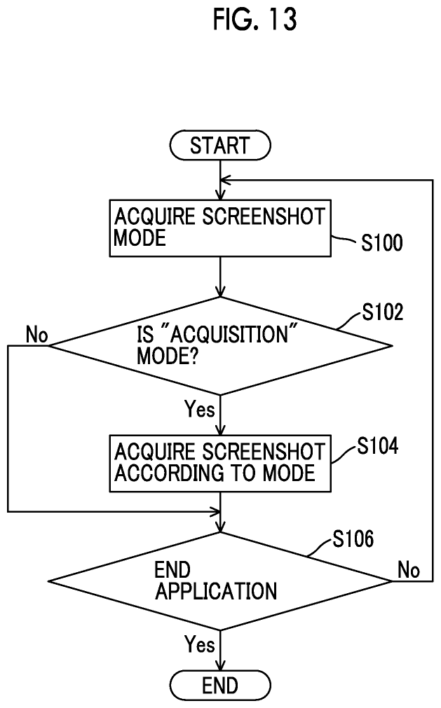

FIG. 13 is a flowchart showing the flow of acquisition of the SCS (72). The flow of FIG. 13 is started at the timing when the printing application is started by the print control apparatus 12 (information processing apparatus). In S100, the processor 20 reads the SCS setting information 67 from the storage device 22. Then, in S102, in a case where the SCS setting information 67 indicates “no acquisition” of the SCS (72) (designation of “no acquisition” of the mode setting portion 81 of FIG. 11) (S102: No), the processor 20 proceeds to S106. On the other hand, in a case where the SCS setting information 67 indicates “acquisition” of the SCS (72) (designation other than “no acquisition” in the mode setting portion 81 of FIG. 11) (S102: Yes), the processor 20 proceeds to S104. In S104, the processor 20 acquires the SCS (72) according to the SCS setting information 67, and stores the acquired SCS (72) in the storage device 22. Then, in S106, the processor 20 checks whether or not the printing application has ended, returns to S100, and repeats the process until the printing application ends.

According to the exemplary embodiment described above, it becomes easier to later check the operation performed by the user on the printing application and the operating system operated by the print control apparatus 12, as compared with the case where only the log information is used.

In the exemplary embodiment described above, in a case where the SCS (72) is acquired as a result of the event related to the print job, identification information on the print job is added to the file names of the user event SCS (72B) and the device event SCS (72C). In this case, the attribute information on the print job may be further added to the file names of the SCSs (72B, 72C). For example, in a case where the print job is a security job (a password is required to be input for editing and processing the print job), the wording indicating “security job” may be added to the file names of SCSs (72B, 72C). Thus, it becomes easier to find the desired SCSs (72B, 72C).

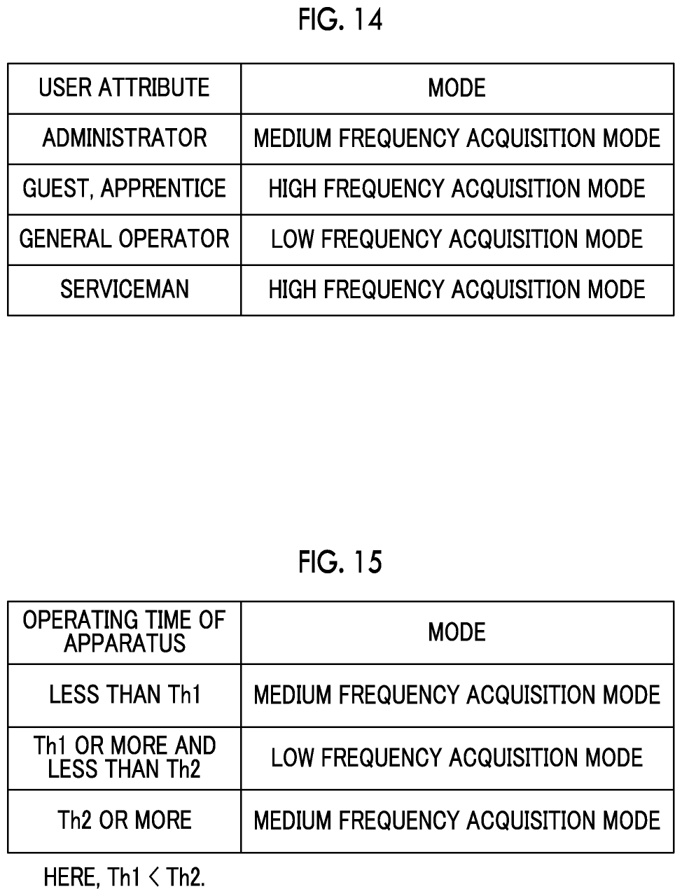

Further, in the exemplary embodiment described above, the user sets the SCS mode in the mode setting portion 81 of the window 80 shown in FIG. 11. However, the SCS mode may be set automatically. For example, as shown in FIG. 14, the SCS mode may be set according to the user attribute. This is a form in which user authentication is performed in a case where the printing application is started, and in a case where the user attribute is recognized from the login ID in the user authentication, the processor 20 automatically sets the SCS mode according to the user attribute. As shown in FIG. 14, in a case where the user attribute is “guest, apprentice”, since the operation on the apparatus is unfamiliar, a failure may often occur or a desired processing result may often not be obtained. Therefore, by setting the SCS mode to the “high frequency acquisition mode”, the number of SCS (72) per unit time is increased, which makes the operation performed by the “guest, apprentice” user is to be easily analyzed from the SCS (72). Further, in a case where the user attribute is “serviceman”, for example, in many cases, the user deals with failures and a case where a desired processing result cannot be obtained, so that the SCS mode is set to the “high frequency acquisition mode”, the number of SCS (72) per unit time is increased to facilitate analysis and verification from the SCS (72). Further, in a case where the user attribute is “administrator” or “general operator”, the operation on the apparatus is more familiar than in the case of “guest, apprentice”, so that it is considered that a failure or the like is less likely to occur. Therefore, in a case where the user attribute is “administrator” or “general operator”, the SCS mode is set to “medium frequency acquisition mode” or “low frequency acquisition mode”.

Further, for example, as shown in FIG. 15, the SCS mode may be set according to the operating time of the print control apparatus 12 or the printing apparatus 14. The failure rate of the apparatus often has a bathtub curve, the failure rate is relatively high for a while (operating time is less than Th1) after the apparatus is in operation, thereafter (operating time is Th1 or more and less than Th2), the failure rate becomes low, and as the operating time of the apparatus becomes long (in a case where the operating time is Th2 or more), the failure rate becomes high again. Therefore, in a case where the failure rate is high, the SCS mode is changed according to the operating time of the apparatus in order to easily analyze the cause of the failure and the personnel from the SCS (72). For example, as shown in FIG. 15, in a case where the “operating time of the apparatus” is less than Th1 or in a case where the “operating time of the apparatus” is Th2 or more, the SCS mode is set to the “medium frequency acquisition mode” (or “high frequency acquisition mode”). In a case where the “operating time of the apparatus” is Th1 or more and less than Th2, the SCS mode is set to the “low frequency acquisition mode”.

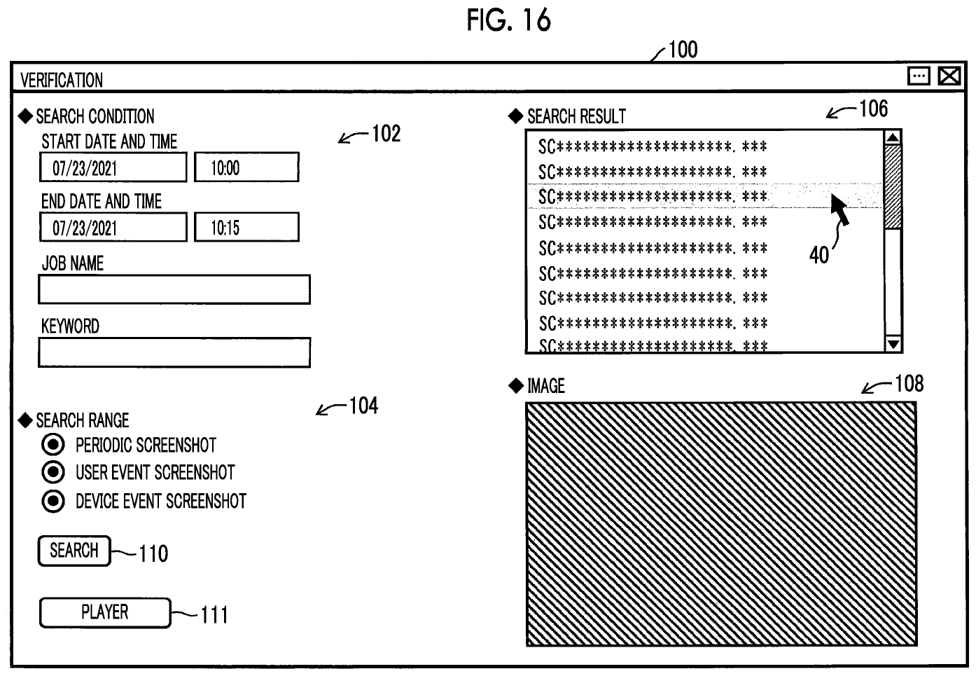

Next, verification using SCS (72) will be described. FIG. 16 is a diagram showing an example of the verification window 100. The functions of the verification window 100 and the player window 120 (see FIG. 18, see below) may be implemented as part of the printing application or as another application. The verification using the verification window 100 and the player window 120 may be performed by the print control apparatus 12, or may be performed by another information processing apparatus.

The verification window 100 includes a search condition input portion 102, a search range setting portion 104, a search result display portion 106, and an image display portion 108. The search condition input portion 102 includes text boxes to which “start date and time”, “end date and time”, “job name”, and “keyword” are respectively input. The “start date and time” and “end date and time” are required to be entered, and the “job name” and “keyword” are arbitrarily entered. In a case where the user inputs the “start date and time” and the “end date and time” and presses the “search” button 110, the SCSs (72) having dates and times between the “start date and time” and the “end date and time” in the file name are searched from the periodic folder 70A, the user event folder 70B, and the device event folder 70C, and are displayed in the search result display portion 106. The search range setting portion 104 has a radio button for each of the periodic SCS, the user event SCS, and the device event SCS, and the SCS with the radio button turned on (black circle is checked) is the search target. That is, whether or not the periodic folder 70A, the user event folder 70B, and the device event folder 70C are search targets is determined by turning the radio button on/off.

Further, in a case where the user inputs the “job name” in the search condition input portion 102 and presses the “search” button 110, the SCSs (72) having the input job name (print job identification information) in the file name are searched and displayed in the search result display portion 106. That is, only the SCSs (72) related to the print job designated in the search condition are displayed in the search result display portion 106.

Further, in a case where the user inputs a “keyword” in the search condition input portion 102 and presses the “search” button 110, the SCSs (72) having the input keyword (for example, an event name) in the file name are searched and displayed in the search result display portion 106. That is, only the SCSs (72) related to the keyword designated in the search condition are displayed in the search result display portion 106.

In the search result display portion 106, the file names of the SCSs (72) that match the search conditions are displayed in chronological order (from the oldest to the newest date and time included in the file names). In a case where the file name of one SCS (72) is designated by the cursor 40 in the search result display portion 106, the image of the SCS (72) is displayed in the image display portion 108.

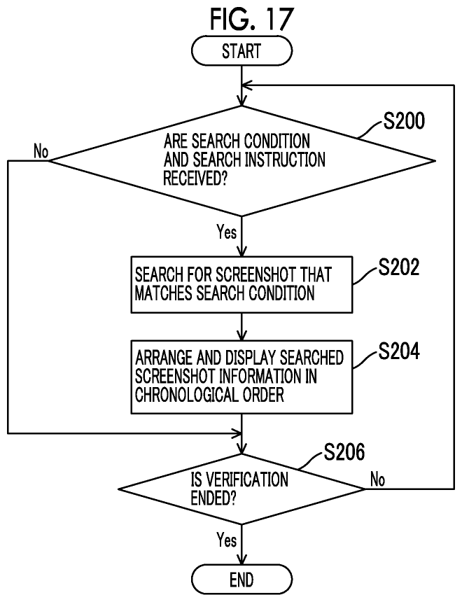

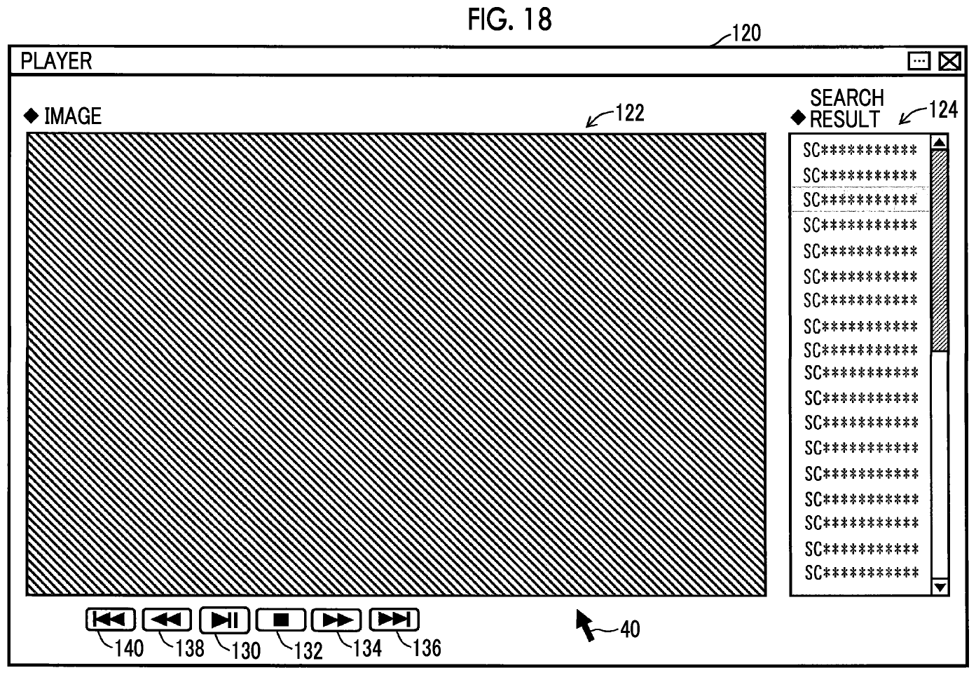

FIG. 17 is a flowchart showing the flow of verification using the SCS (72). In S200, the processor 20 checks whether or not the search condition (input to the search condition input portion 102 in FIG. 16) and the search instruction (pressing the “search” button 110 in FIG. 16) have been received. In a case of No in S200, the process proceeds to S206. On the other hand, in a case of Yes in S200, in S202, the processor 20 searches for SCS (72) that matches the search condition. Then, in S204, the processor 20 performs control to display the searched file names of the SCSs (72) in chronological order in the search result display portion 106 of FIG. 16. The processor 20 repeats the above processing until the verification window 100 of FIG. 16 is closed (S206 becomes Yes).

According to the verification window 100, in a case where a failure or a desired processing result is not obtained, it is possible to check only SCS (72) narrowed down by a period (start date and time to end date and time) according to the occurrence date and time of an error or the like, a job name, and a keyword in the search conditions. Therefore, there is an increased possibility that the cause or factor of the failure or obtaining the undesired processing results can be quickly found from the SCS (72).

Here, the verification window 100 includes a “player” button 111. In a case where the user presses the “player” button 111, the player window 120 (see FIG. 18) opens. As shown in FIG. 18, the player window 120 includes an image display portion 122, a search result display portion 124, and a plurality of buttons 130 to 140. In the search result display portion 124, the same contents as the contents of the search result display portion 106 of the verification window 100 are displayed. That is, the file names of the searched SCS (72) are displayed in chronological order In the search result display portion 124.

The plurality of buttons 130 to 140 include a play/pause button 130, a stop button 132, a fast forward button 134, a skip button 136, a rewind button 138, and a reverse skip button 140. In a case where the user presses the play/pause button 130, the SCSs (72) in the search result display portion 124 are designated in order from top to bottom (the backgrounds of the SCS file names are grayed out in order), and the image of the designated SCS (72) is displayed on the image display portion 122. That is, the image of the SCS (72) is displayed by frame advance on the image display unit 122. Further, in a case where the user presses the play/pause button 130 again, the frame advance is paused.

The stop button 132 is a button for stopping frame advance, and in a case where the stop button 132 is pressed, the SCS (72) at the top of the search result display portion 124 is designated. The fast forward button 134 is a button for increasing the speed of frame advance. The rewind button 138 is a button for returning again and checking the image of the SCS (72) that has already been frame-advanced. The skip button 136 is a button for jumping the designation of the SCS (72) in the search result display portion 124 to the next user event SCS (72B) or device event SCS (72C). The reverse skip button 140 is a button for returning the designation of the SCS (72) in the search result display portion 124 to the user event SCS (72B) or the device event SCS (72C) that have already been frame-advanced.

By using the player window 120 as shown in FIG. 18, it is possible to quickly check the cause and the factor for the failure and the processing result.

In the exemplary embodiment described above, the printing application of the print control apparatus 12 acquires the periodic SCS (72A), the user event SCS (72B), or the device event SCS (72C). However, an exemplary embodiment of acquiring at least one of a periodic SCS (72A), a user event SCS (72B), and a device event SCS (72C) can also be applied to various applications operating on information processing apparatuses such as PCs, tablets, and smartphones. By checking these SCSs (72), in a case where a failure or an unintended processing result occurs in an application operating on a PC, a tablet, a smartphone, or the like, or an apparatus controlled by the application, it is easier to verify the cause and factor thereof.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a copy image, that is a copy of an image displayed on a display device, every time a predetermined timing occurs; and
store the acquired copy image in a storage device in association with information indicating the predetermined timing that triggers the acquisition.

2. The information processing apparatus according to claim 1, wherein the processor is configured to:
repeatedly acquire the copy image at a predetermined time interval, and
store the acquired copy image in the storage device in association with acquisition date and time.

3. The information processing apparatus according to claim 2, wherein the processor is configured to:
receive designation of a first mode or a second mode from a user, and
in a case where the designation of the second mode is received, the predetermined time interval is shortened as compared with a case where the designation of the first mode is received.

4. The information processing apparatus according to claim 1, wherein the processor is configured to:
acquire the copy image at a timing when a user performs a predetermined operation on an application operating in the information processing apparatus, and
store the acquired copy image in the storage device in association with information indicating the predetermined operation performed by the user.

5. The information processing apparatus according to claim 4,
wherein the application is an application that controls a printing apparatus based on a print job, and
the processor is configured to:
in a case where the predetermined operation is a user's operation related to setting or processing of the print job,
store the acquired copy image in the storage device in association with identification information on the print job related to the user's operation that triggers the acquisition.

6. The information processing apparatus according to claim 4, wherein the processor is configured to:
store the acquired copy image in the storage device in association with date and time when the user performs the predetermined operation that triggers the acquisition.

7. The information processing apparatus according to claim 5, wherein the processor is configured to:
store the acquired copy image in the storage device in association with date and time when the user performs the predetermined operation that triggers the acquisition.

8. The information processing apparatus according to claim 1, wherein the processor is configured to:
acquire the copy image at a timing when a predetermined event of an application operating in the information processing apparatus or a predetermined event of an apparatus controlled by the application occurs, and
store the acquired copy image in the storage device in association with information indicating the predetermined event that has occurred.

9. The information processing apparatus according to claim 8,
wherein the application is an application that controls a printing apparatus based on a print job, and
the processor is configured to:
in a case where the predetermined event is an event related to processing of the print job,
store the acquired copy image in the storage device in association with identification information on the print job related to an event that triggers the acquisition.

10. The information processing apparatus according to claim 8, wherein the processor is configured to:
store the acquired copy image in the storage device in association with date and time when the predetermined event that triggers the acquisition occurs.

11. The information processing apparatus according to claim 9, wherein the processor is configured to:
store the acquired copy image in the storage device in association with date and time when the predetermined event that triggers the acquisition occurs.

12. The information processing apparatus according to claim 1, wherein the processor is configured to:
in a case where the acquired copy image contains confidential information,
perform a concealment process on an area where the confidential information of the copy image appears, and update the copy image.

13. The information processing apparatus according to claim 2, wherein the processor is configured to:
in a case where the acquired copy image contains confidential information,
perform a concealment process on an area where the confidential information of the copy image appears, and update the copy image.

14. The information processing apparatus according to claim 3, wherein the processor is configured to:
in a case where the acquired copy image contains confidential information,
perform a concealment process on an area where the confidential information of the copy image appears, and update the copy image.

15. The information processing apparatus according to claim 4, wherein the processor is configured to:
in a case where the acquired copy image contains confidential information,
perform a concealment process on an area where the confidential information of the copy image appears, and update the copy image.

16. The information processing apparatus according to claim 5, wherein the processor is configured to:
in a case where the acquired copy image contains confidential information,
perform a concealment process on an area where the confidential information of the copy image appears, and update the copy image.

17. The information processing apparatus according to claim 6, wherein the processor is configured to:
in a case where the acquired copy image contains confidential information,
perform a concealment process on an area where the confidential information of the copy image appears, and update the copy image.

18. The information processing apparatus according to claim 7, wherein the processor is configured to:
in a case where the acquired copy image contains confidential information,
perform a concealment process on an area where the confidential information of the copy image appears, and update the copy image.

19. A non-transitory computer readable medium storing a program causing a computer to execute a process comprising:
acquiring a copy image, that is a copy of an image displayed on a display device, every time a predetermined timing occurs; and
storing the acquired copy image in a storage device in association with information indicating the predetermined timing that triggers the acquisition.

20. An information processing method comprising:
acquiring a copy image, that is a copy of an image displayed on a display device, every time a predetermined timing occurs; and
storing the acquired copy image in a storage device in association with information indicating the predetermined timing that triggers the acquisition.
